(19) United States
(12) Patent Application Publication
(10) Pub. No.: US 2006/0011457 A1
(43) Pub. Date: Jan. 19, 2006

(54) Deadman switch

(76) Inventor: Timothy Bernard Robertson, Portland (AU)

Correspondence Address: STITES & HARBISON PLLC, 1199 NORTH FAIRFAX STREET, SUITE 900, ALEXANDRIA, VA, 22314, US

(21) Appl. No.: 11/183,164

(22) Filed: Jul. 18, 2005

(30) Foreign Application Priority Data
Jul. 19, 2004 (AU) 2004903982

(51) Int. Cl. H01H 13/70

(52) U.S. Cl. 200/51 LM

(57) ABSTRACT

A deadman switch adapted to form an integral part of a hand held end connector of a hazardous hand tool, the deadman switch comprising a housing integrally formed with the connector, the housing including switching means arranged to control operation of the tool, a handle pivotally supported by the housing to be displaceable from an off position to an on position in which the handle activates the switching means to control operation of the tool, and means to urge the switching means and handle to the off position, whereby in use the connector is hand held to depress the handle to activate the switching means and cause operation of the tool.

This invention relates to a deadman switch, particularly for use in the sand blasting industry.

In heavy industrial sand blasting the handling of the sand blasting hose and output nozzle is a very dangerous practice. The high pressure in a sand blasting hose means that if the hose is accidentally dropped, it has a tendency of performing an uncontrollable whipping motion. The size and weight of the hose and nozzle together with the pressures involved means that the random motion of the end of the hose is extremely dangerous and it has been known to cause serious injury and even death.

One means of preventing dangers of this kind is to install a deadman switch onto the hose that causes the pressure to be immediately cutoff once the switch is released. Thus, deadman switches have been incorporated on the end of the hose. These switches have to be held down by the operator and are activated once the operator releases the end of the hose.

Unfortunately, conventional deadman switches have very poor ergonomics which cause users to either remove the switches totally or to put the switches into the hands of another party. If another party is holding the deadman switch there is often a delay between an accident and that party activating the switch. Both these practices are clearly undesirable and it is viewed that there is a need for a much more ergonomically friendly deadman switch that can be formed with the connector in a manner that it can not be detached.

It is these issues that have brought about the present invention.

In accordance with one aspect of the present invention there is provided a deadman switch adapted to form an integral part of a hand held end connector of a hazardous hand tool, the deadman switch comprising a housing integrally formed with the connector, the housing including switching means arranged to control operation of the tool, a handle pivotally supported by the housing to be displaceable from an off position to an on position in which the handle activates the switching means to control operation of the tool, and means to urge the switching means and handle to the off position, whereby in use the connector is hand held to depress the handle to activate the switching means and cause operation of the tool.

Preferably the switching means comprises a valve assembly within the housing, the valve assembly comprising a valve member located within a valve chamber adapted to be connected to air inlet and outlet lines, whereby depression of the handle displaces the valve member to cause operation of the tool.

Preferably, the switch includes a releasable latch that operates to hold the handle in the off position.

The handle is preferably ergonomically designed to run parallel to the tool so that the tool can be used single handedly with the hand holding the tool also holding down the handle.

In a preferred embodiment the deadman switch is adapted to form part of the end connector of a high pressure sand blaster.

An embodiment of the present invention will now be described by way of example only with reference to the accompanying drawings in which:

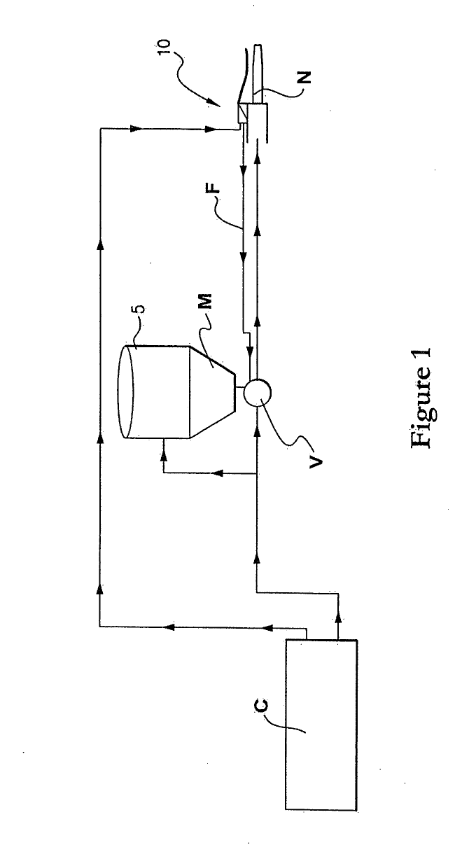

FIG. 1 is a schematic illustration of a sand blasting circuit,

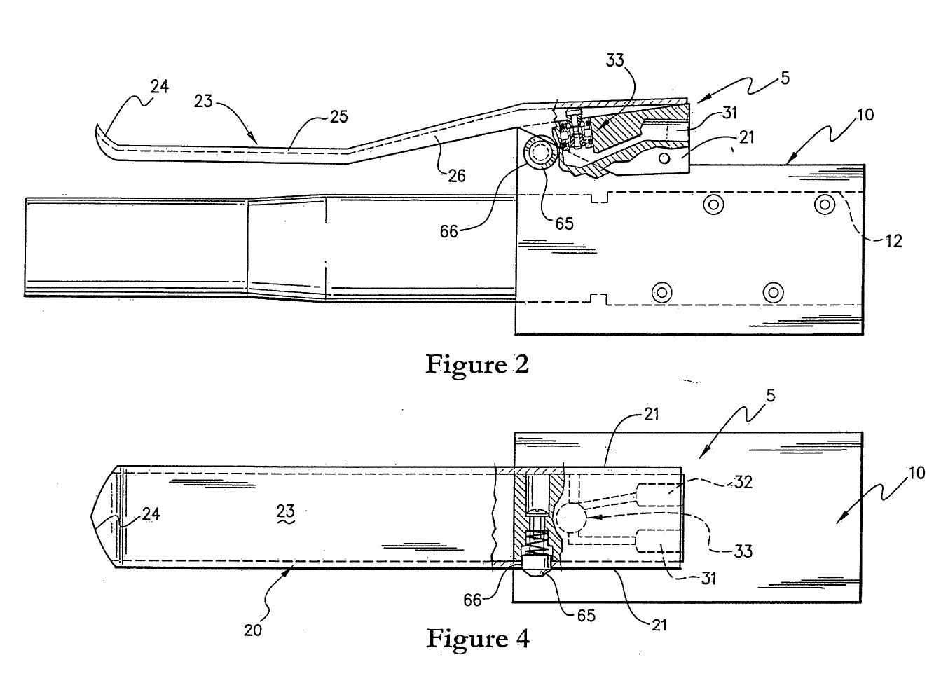

FIG. 2 is a side elevational view of a nozzle connector incorporating a deadman switch in the off position,

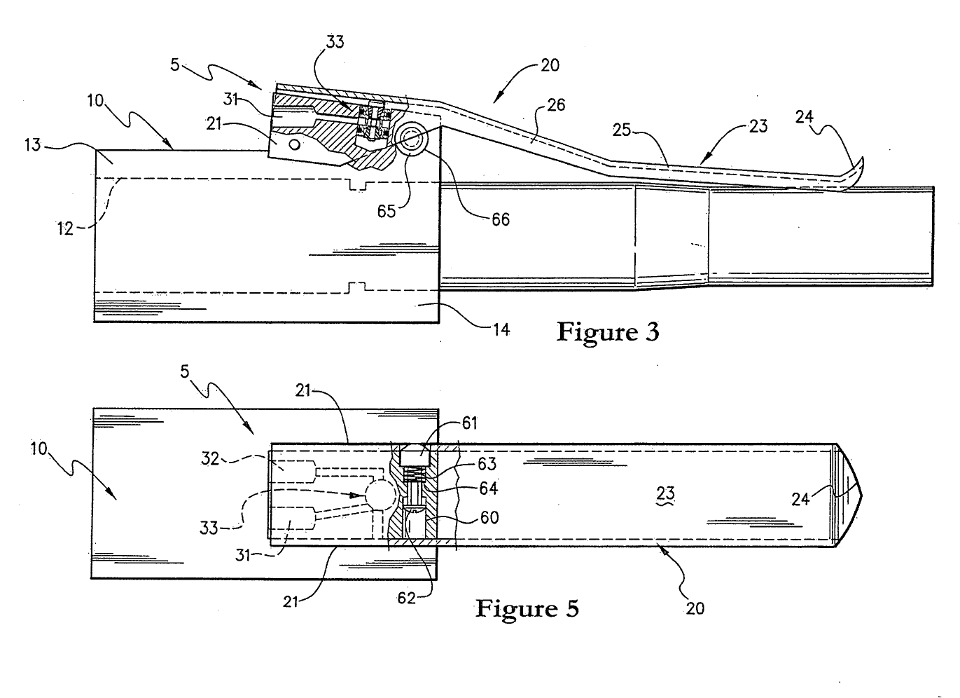

FIG. 3 is a side elevational view of the connector and deadman switch in the on position,

FIG. 4 is a plan view of the connector and deadman switch in the off position,

FIG. 5 is a plan view of the connector and deadman switch in the on position,

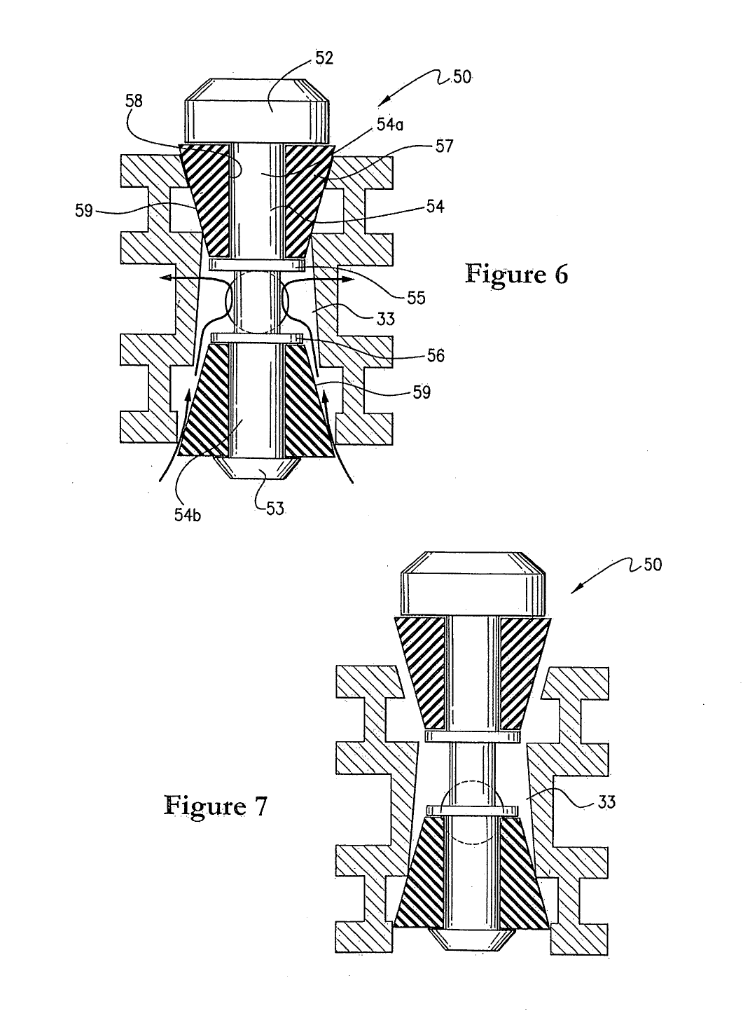

FIG. 6 is a detailed elevational view a valve forming part of the deadman switch in the on position,

FIG. 7 is a elevational view the valve in the off position,

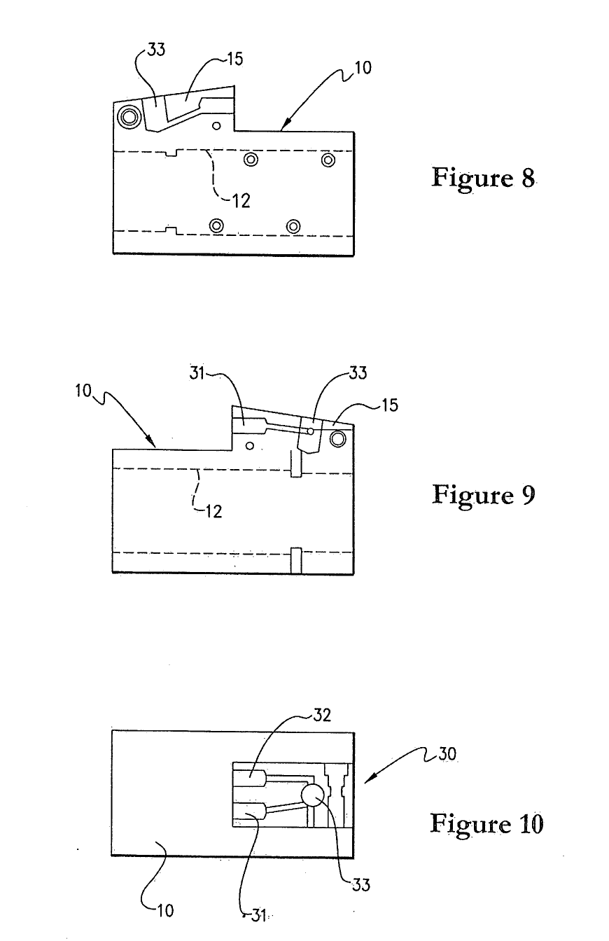

FIG. 8 is a side elevational view of the connector,

FIG. 9 is another side elevational view of the connector,

FIG. 10 is a plan view of the connector,

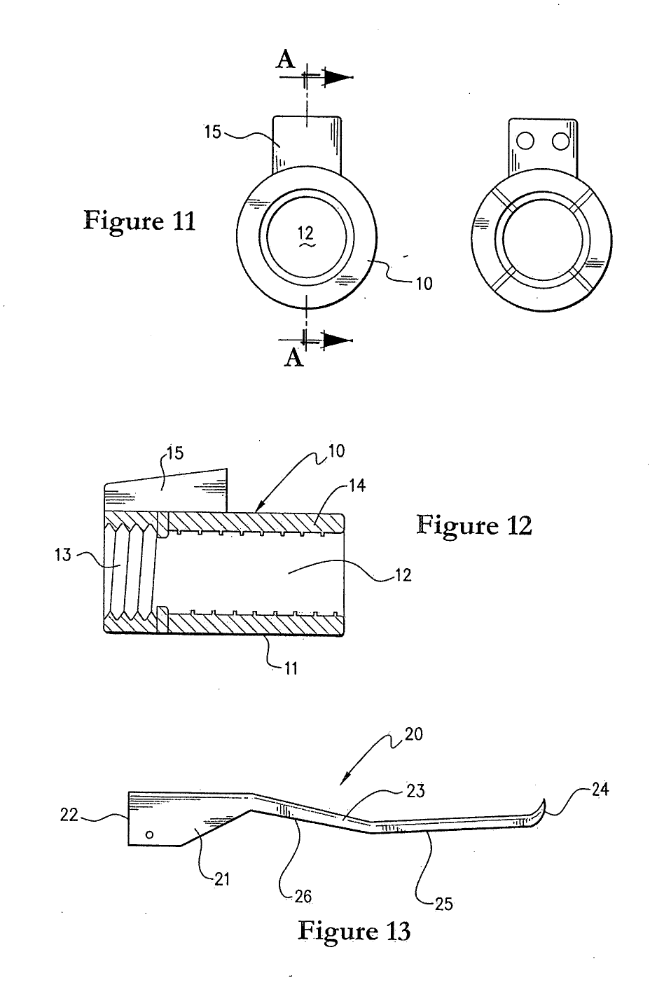

FIG. 11 is an end elevational view of the connector,

FIG. 12 is a cross sectional view taken along the lines A-A of FIG. 11, and

FIG. 13 is a side elevational view of a handle forming part of the deadman switch.

As shown in the accompanying drawings, a deadman switch has been designed for particular use with high pressure sand blasting equipment. As shown in FIG. 1, equipment of this kind incorporates a high pressure air compressor C and a sand or other aggregate hopper 5 that are joined to a mixer M where the sand and air is mixed. The output of the mixer M is coupled to a miser valve V that controls flow to a flexible hose (not shown). The flexible hose terminates in a connector 10 on which suitable nozzles N can be attached in dependence on the requirements of the sand blaster.

The user of the equipment holds the connector 10 and points the nozzle N at the object that is to be sand blasted. It is commonplace for the hose to be held under the arm of the user so that the user can withstand the sideways movement that the high pressure air source imparts to the hose. A deadman switch 5 is designed to be part of the connector 10 and in essence comprises a handle 20 that when pressed down places a switch in the on position. When the handle 20 is released the switch automatically returns to the off position which has the effect of closing off a feedback line F to the miser valve V to in turn immediately close off the main pressure that drives the sand blasting hose. It is understood that the switch can be electrical or pneumatic.

As shown in FIGS. 8-13, the connector 10 includes a cylindrical housing 11 with a elongate bore 12 through which the high pressure sand and air mixture passes. The forward end of the connector includes an internally threaded bore 13 that is adapted to threadedly engage the externally threaded end of a variety of nozzles. The opposite end 14 of the connector is adapted to be firmly secured to the end of heavy duty high pressure hose. Integrally formed with the connector body is a deadman switch mount 15 that is adapted to support the handle 20 of the switch 5 whilst at the same time house a valve chamber 30 and an air inlet 31 and air outlet 32 which are in turn coupled to low pressure feedback lines F1 and F2 that are in turn coupled to the miser valve V back at the source of the high pressure air and aggregate mixture. The deadman switch handle 20 is shown in FIG. 13 and comprises a U-shaped forward end 21 with downwardly extending flanges 22 that sit on either side of the mount 15 of the connector 10 and are secured to the connector by fasteners (not shown) that allow the handle 20 to pivot about the connector 10. The forward end 21 of the handle has a rearwardly trailing lever portion 23 that terminates in an upturn toe 24 which has been designed to prevent the likelihood of a user's hand sliding off the rear of the handle 20. The underside of the handle has a horizontal portion 25 adjacent the toe 25 which then merges into an inclined portion 26 which extends up to the U-shaped forward end 21. The inclined portion 26 serves as an abutment surface for actuating a valve member 50 that is located in a vertical bore 33 in the valve chamber 30. The vertical bore 30 joins two spaced air conduit chambers 31, 32 and the valve member 50 is displaceable from an on position in which air flows between the chambers and through the bore and a closed position in which air can not pass from one conduit to the other.

FIGS. 6 and 7 show the valve member 50 in greater detail. The valve member 50 comprises a valve support member 51 that has a head 52 joined to an end flange 53 by a cylindrical shank 54. Two spaced shoulders 55 and 56 separate the shank 54 into upper and lower portions 54a and 54b. A frustoconical rubber seal 57 with an internal bore 58 is located on each shank 54a and 54b with the narrower ends of the seals facing each other. The rubber seals are held into position by the head 52 and shoulder 55 on the one hand and the shoulder 56 and the end flange on the other.

In the off position shown in FIG. 7, the air pressure from the inlet conduit acts on the underside of the valve member to urge it upwardly to the position shown in FIG. 7 where the frustoconical side wall 59 of the valve engages the wall of the bore 33 to prevent air flow into the valve chamber. When the head 52 of the valve is depressed by the handle to the position shown in FIG. 6 the lower valve member is moved clear of the wall of the bore 33 allowing air to flow past the valve member and into the center of the valve chamber and out through the outlet passage. Escape of air up through the top of the valve chamber 33 is stopped by the upper valve member as its frustoconical wall 59 engages the top of the wall of the bore 33. Once the air flows from the inlet to the outlet, the miser valve operates to operate the sand blasting equipment. The air pressure on the base of the valve member 50 urges the valve member up and assists in returning the handle to the off position.

As shown in FIGS. 2 to 5, the mount 15 for the handle 20 also includes a horizontal bore 60 which is located at a press-stud 61 that is screwed onto the end of the bolt 62 with a spring 63 therebetween acting on an internal shoulder 64 within the bore 60. The spring 43 urges the press-stud 61 out and the press-stud 61 has a frustoconically tapered head 65 that fits into an aperture 66 of one flange 21 of the handle 20 so that, as shown in FIGS. 2 and 4, when the handle 20 is in the off position the stud 61 locates within the hole 66 in the flange 21 preventing downward depression of the handle 20.

To release the deadman switch 5 it is necessary to first push in the head 65 of the stud 61 clear of the aperture 66 and then press down on the handle 20. This in turn moves the valve member 50 to cause flow of air through the feedback loop to in turn activate the high pressure miser valve V. If the handle 20 is accidentally released, the handle is immediately urged upwardly by both the air pressure that acts on the valve member 50 which pushes the handle up as shown in FIG. 2,and the tapered head 65 on the stud 61 also has the effect of imparting a vertical force on the handle 20 that causes it to move upwardly to the off position.

Thus, any release of the handle 20 immediately causes the deadman switch 5 to assume the off position which in turn causes immediate cessation of the high pressure delivery of particulate material and air.

The handle 20 of the switch 5 is ergonomically designed to be comfortable and easy to use. The upturned end 24 prevents the hand from sliding off and it is of sufficient length that it does not cause any major inconvenience to the user of the sand blasting equipment. The connector 10 is also designed in a manner that it is impossible to tamper with the deadman switch. Any attempt to remove the handle causes the valve to automatically assume the off position so there is no possibility of disarming the deadman switch or moving the switch to another position. If the operator wishes to use the equipment then it is essential that the deadman switch is depressed for operation to take place.

Obvious disabling of the switch, such as using tape or other means to hold the handle down, would be highly conspicuous and would contravene a variety of health and safety regulations.

The handle is designed so that instead of extending rearwardly in a direction parallel to the hose, it could extend forwardly of the connector in situations where the nozzle component (not shown) needs to be held. The length of the handle would vary in dependence on the size of the nozzle and it is understood that the componentry of the deadman switch would be either injection moulded in plastics or die cast in suitable metals. It is further understood that to prevent the possibility of grit or dirt impeding the motion of the release stud 61, a small O-ring seal can be provided on the head 65 of the stud 61 to prevent the ingress of particulate material.

Whilst a pneumatic valve is the preferred form of switching means it is understood that the connector could include an electrical switch with either a wired or wireless connection to the miser valve V.

It is further understood that the deadman switch could be used on a variety of other hazardous hand tools.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Having discussed by invention, what I claim is:

1. A deadman switch adapted to form an integral part of a hand held end connector of a hazardous hand tool, the deadman switch comprising a housing integrally formed with the connector, the housing including switching means arranged to control operation of the tool, a handle pivotally supported by the housing to be displaceable from an off position to an on position in which the handle activates the switching means to control operation of the tool, and means to urge the switching means and handle to the off position, whereby in use the connector is hand held to depress the handle to activate the switching means and cause operation of the tool.

2. The deadman switch according to claim 1 wherein the switching means comprises a valve assembly within the housing, the valve assembly comprising a valve member located within a valve chamber adapted to be connected to air inlet and outlet lines, whereby depression of the handle displaces the valve member to cause operation of the tool.

3. The deadman switch according to claim 1 wherein a releasable latch operates to hold the handle in the off position.

4. The deadman switch according to claim 3 wherein the latch comprises a stud mounted on a spring in the housing and urged by the spring to engage an aperture in the handle to prevent movement of the handle relative to the housing, the stud having to be compressed to allow the handle to move.

5. The deadman switch according to claim 4 wherein the head of the stud is tapered so that when it engages the handle the spring force has a component that urges the handle to the off position.

6. The deadman switch according to claim 1 wherein the handle extends parallel to the end connector so the tool can be used single handedly.

7. The deadman switch according to claim 1 wherein the handle is elongate with an upturned end.

8. Hand held connector for a high pressure sand blaster the connector adapted at one end to be connected to a source of high pressure air and sand and at the other to a nozzle, the connector comprising a throughway for passage at the air and sand, the connector including as an integral part thereof a deadman switch comprising a housing integrally formed with the connector, the housing defining a valve chamber containing a valve member, the valve chamber being adapted to be connected to air inlet and outlet lines, a handle pivotally supported by the housing to be displaceable from an off position to an on position in which the handle displaces the valve member to open the valve and allow air flow between the inlet and outlet lines, and means to urge the valve member and handle to the off position, whereby in use, the connector is hand held to depress the handle to open the valve to cause passage of the high pressure air and sand.

9. The hand held connector according to claim 8 wherein the handle is positioned substantially parallel to the connector to extend either towards or away from the nozzle.
